(19) United States
(12) Patent Application Publication
(10) Pub. No.: US 2015/0371180 A1
(43) Pub. Date: Dec. 24, 2015

(54) PROCESSING DEVICE, PROCESSING METHOD, PROGRAM, AND RECORDING MEDIUM

(71) Applicant: RAKUTEN, INC., Shinagawa-ku, Tokyo (JP)

(72) Inventor: Mikiko MATSUURA, Tokyo (JP)

(73) Assignee: Rakuten, Inc., Tokyo (JP)

(21) Appl. No.: 14/765,911

(22) PCT Filed: Oct. 30, 2013
(86) PCT No.: PCT/JP2013/079374

§ 371 Date: Aug. 5, 2015

(51) Int. Cl. G06Q 10/08; G06F 17/30

(52) U.S. Cl. CPC G06Q 10/087; G06F 17/30371; G06F 17/30303

(57) ABSTRACT

After a keyword is entered, an acquirer (101) sorts the category names of products that match the keyword in the descending order of the number of products associated with the category name among the products that match the keyword to acquire the category names which have higher or equal to ranks than a predetermined rank. As a category name is entered, a determiner (102) determines that at least either one of the entered keyword and entered category name is entered incorrectly when the entered category name and acquired category name do not match. When the determiner (102) affirms incorrect input, an indicator (103) indicates replacement of the entered category name with a category name ranked higher than the entered category name.

### TECHNICAL FIELD

The present disclosure relates to a processing device, processing method, program, and non-transitory recording medium for determining whether there is incorrect input within entered information regarding a product.

### BACKGROUND ART

Conventionally, information regarding a product dealt with at a shopping site or auction site on the Internet such as a product name, product category name, and product description is registered in a products database managing all products dealt with at the site by the user selling or exhibiting the product (for example, see Patent Literature 1).

### CITATION LIST

### Patent Literature

Patent Literature 1: Unexamined Japanese Patent Application Kokai Publication No. 2010-113390.

### SUMMARY OF INVENTION

### Technical Problem

When information regarding a product is registered in the products database, the information should be entered correctly by the user selling or exhibiting the product. However, the information is entered manually and therefore there is a possibility of incorrect input due to a typo or the like.

The present disclosure is made with the view of the above situation and an objective of the disclosure is to provide a processing device, processing method, program, and recording medium that can prevent incorrect input of information regarding a product.

### Solution to Problem

In order to achieve the above objective, the processing device according to a first exemplary aspect of the present disclosure comprises:

an acquirer that, after a keyword is entered, sorts the category names of products that match the keyword in the descending order of the number of products associated with the category name among the products that match the keyword to acquire the category names which have higher or equal to ranks than a predetermined rank; and

a determiner that, as a category name is entered, determines that either the entered keyword and/or entered category name have been entered incorrectly when the entered category name and acquired category name do not match.

The processing device according to the above aspect further comprises:

an indicator identifying a category name ranked higher than the entered category name among the sorted category names and indicating replacement of the entered category name with the identified category name when it is determined that either the entered keyword and/or the entered category name have been entered incorrectly.

In the processing device according to the above aspect,

the indicator indicates replacement with any of a given number of higher-ranking category names when there are multiple category names ranked higher than the entered category name.

In the processing device according to the above aspect,

the keyword is a product name.

In the processing device according to the above aspect,

the determiner determines that either the entered product name and/or entered category name have been entered incorrectly when the entered category name and the acquired category name do not match and the entered product name matches none of product names corresponding to the entered category name.

In the processing device according to the above aspect,

after product description is entered, the determiner determines that at least either one of the entered product name and entered product description is entered incorrectly when the entered category name and the acquired category name do not match and the entered product name does not appear in the entered product description.

In the processing device according to the above aspect,

the keyword is part of product description.

The processing method according to a second exemplary aspect of the present disclosure is a processing method executed by a processing device comprising an acquirer and a determiner, comprising:

an acquisition step in which after a keyword is entered, the acquirer sorts the category names of products that match the keyword in the descending order of the number of products associated with the category name among the products that match the keyword to acquire the category names which have higher or equal to ranks than a predetermined rank; and

a determination step in which as a category name is entered, the determiner determines that either the entered keyword and/or entered category name have been entered incorrectly when the entered category name and acquired category name do not match.

The program according to a third exemplary aspect of the present disclosure allows a computer to function as:

an acquirer that, after a keyword is entered, sorts the category names of products that match the keyword in the descending order of the number of products associated with the category name among the products that match the keyword to acquire the category names which have higher or equal to ranks than a predetermined rank; and

a determiner that, as a category name is entered, determines whether either the entered keyword and/or entered category name have been entered incorrectly when the entered category name and acquired category name do not match.

The computer-readable recording medium according to a fourth exemplary aspect of the present disclosure records a program that allows a computer to function as:

an acquirer that, after a keyword is entered, sorts the category names of products that match the keyword in the descending order of the number of products associated with the category name among the products that match the keyword to acquire the category names which have higher or equal to ranks than a predetermined rank; and

a determiner that, as a category name is entered, determines that either the entered keyword and/or entered category name have been entered incorrectly when the entered category name and acquired category name do not match.

### Advantageous Effects of Invention

The present disclosure can prevent incorrect input of information regarding a product.

### BRIEF DESCRIPTION OF DRAWINGS

FIG. 1 is an illustration showing the configuration of the information processing system according to an embodiment;

FIG. 2 is an illustration showing exemplary data saved in the products database;

FIG. 3 is a schematic block diagram showing the hardware configuration of the processing device;

FIG. 4 is a schematic block diagram showing the functional configuration of the processing device;

FIG. 5 is an illustration showing an exemplary product registration page;

FIG. 6 is an illustration showing exemplary results of the acquirer sorting the category names by the number of corresponding products;

FIG. 7 is an illustration showing an exemplary product registration page; and

FIG. 8 is an exemplary flowchart of the product registration procedure.

### DESCRIPTION OF EMBODIMENTS

An embodiment of the present disclosure will be described in detail with reference to the drawings.

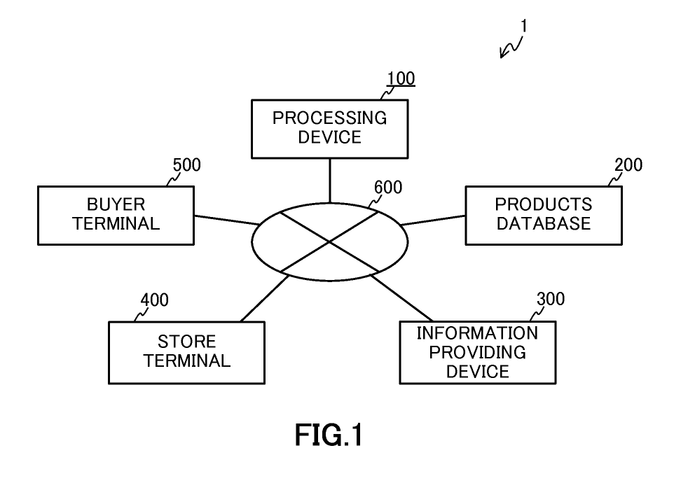

FIG. 1 shows the configuration of an information processing system 1 according to an embodiment of the present disclosure. The information processing system 1 is a system managing the products sold at an online shopping site. As shown in FIG. 1, the information processing system 1 comprises a processing device 100, a products database 200, an information providing device 300, a store terminal 400, and a buyer terminal 500. These devices are communicably connected to each other via the Internet 600.

The processing device 100 is a computer system checking information of a product entered from the store selling the product and registering the product in the products database 200. More specifically, the processing device 100 acquires information regarding a product entered by the store from the store terminal 400. Then, if there is incorrect input in the acquired information, the processing device 100 indicates so and urges retyping. On the other hand, if there is no incorrect input in the acquired information, the processing device 100 registers the acquired information in the products database 200.

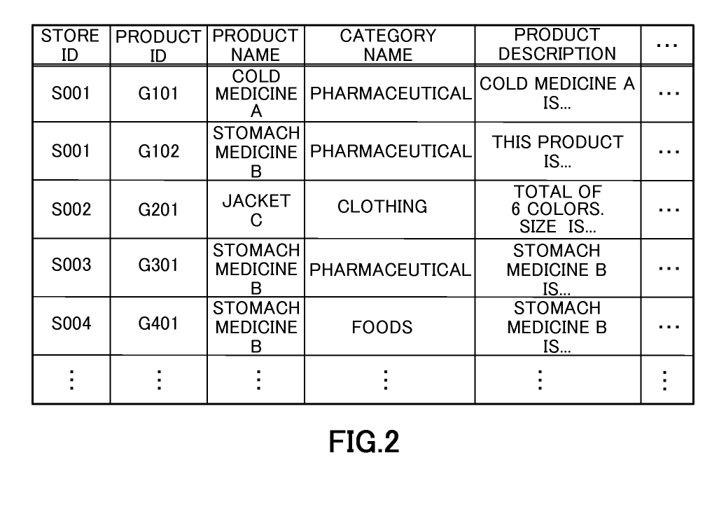

The products database 200 is a device storing information regarding the products the stores sell. FIG. 2 shows exemplary data stored in the products database 200. In the example shown in FIG. 2, the products database 200 stores for each product a store ID of the store that sells the product, a product ID of the product, the name of the product, the category name to which the product belongs, and description of the product. Various data stored in the products database 200 are registered, updated, or deleted by the processing device 100 based on an information acquired from the store terminal 400.

The information providing device 300 is a computer system providing various web pages of the online shopping site, searching the products database 200 for a product, and receiving an order in response to request from the buyer terminal 500.

The store terminal 400 is a computer operated by a store selling products at the online shopping site. Although one store terminal 400 is shown in FIG. 1, the number of store terminals 400 is not limited thereto.

The buyer terminal 500 is a computer operated by a user viewing, searching for, and/or purchasing a product at the online shopping site. Although one buyer terminal 500 is shown in FIG. 1, the number of buyer terminals 500 is not limited thereto.

The configuration of the processing device 100 will be described in detail hereafter.

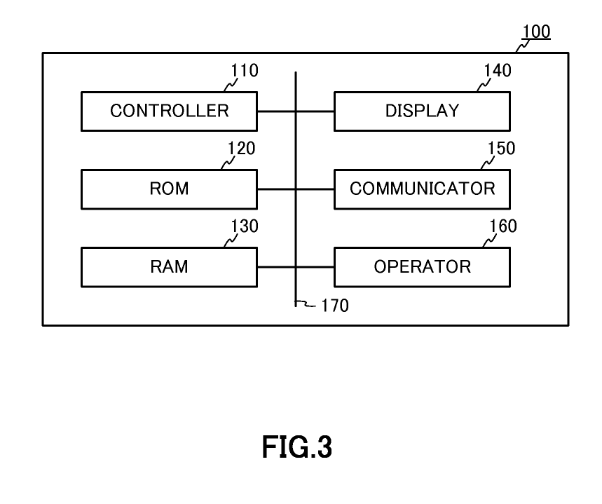

FIG. 3 is a schematic block diagram showing the hardware configuration of the processing device 100. As shown in FIG. 3, the processing device 100 comprises a controller 110, a ROM (Read Only Memory) 120, a RAM (Random Access Memory) 130, a display 140, a communicator 150, and an operator 160. These components are connected by a bus 170.

The controller 110 comprises, for example, a CPU (Central Processing Unit) and controls the entire processing device 100.

The ROM 120 is a nonvolatile memory saving programs for the controller 110 to control the entire processing device 100 and various data.

The RAM 130 is a volatile memory for temporarily saving information created by the controller 110 and data necessary for creating the information.

The display 140 comprises a display device comprising an LCD (Liquid Crystal Display), backlight, and the like. The display 140 displays, for example, data output from the controller 110 under the control of the controller 110.

The communicator 150 comprises a communication interface for connecting the processing device 100 to the Internet 600.

The operator 160 comprises an input device such as a button, touch panel, and keyboard. The operator 160 receives input of operation from the user and outputs operation input signals corresponding to the received operation input to the controller 110.

The functional configuration of the processing device 100 will be described hereafter.

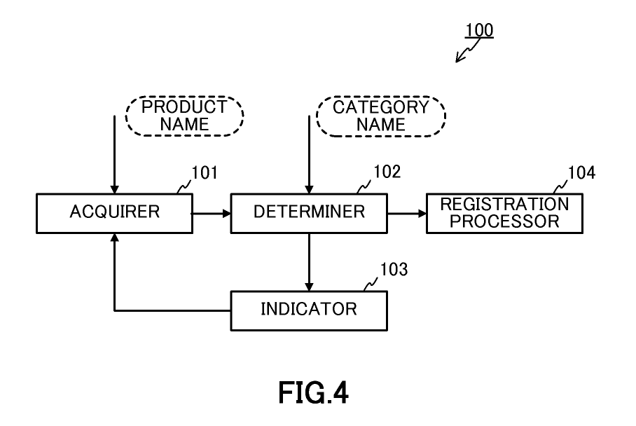

FIG. 4 is a schematic block diagram showing the functional configuration of the processing device 100. As shown in FIG. 4, the processing device 100 comprises an acquirer 101, a determiner 102, an indicator 103, and a registration processor 104.

As a product name is entered, the acquirer 101 sorts the category names of products that match the product name in the descending order of the number of products associated with the category name among the products that match the product name to acquire the category names which have higher or equal to ranks than a predetermined rank.

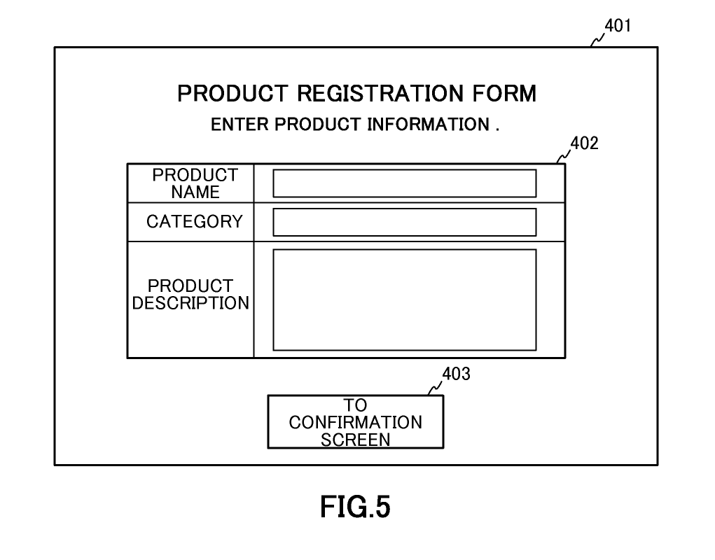

More specifically, the acquirer 101 provides a product registration page for registering a product in the products database 200 to the store terminal 400. FIG. 5 shows an exemplary product registration page 401 provided to the store terminal 400. The product registration page 401 shown in FIG. 5 is displayed on the display of the store terminal 400 and the user of the store terminal 400 enters the product name the user wishes to register in the products database 200, the category name of the product, and description of the product in an entry form 402 contained in the product registration page 401. Then, as a button 403 is selected by the user of the store terminal 400, the store terminal 400 outputs data entered in the entry form 402 (registration request data) to the processing device 100. The acquirer 101 acquires the product name from the registration request data received from the store terminal 400.

Then, acquiring the product name from the store terminal 400, the acquirer 101 identifies products that match the acquired product name in the products database 200. Then, the acquirer 101 identifies, for each of the identified products, the category name associated with the product. For example, if the acquirer 101 receives a product name “STOMACH MEDICINE B” from the store terminal 400, the acquirer 101 identifies, for example, the products having product IDs “G102,” “G301,” and “G401” as products that match “STOMACH MEDICINE B” in the products database 200 shown in FIG. 2. Then, the acquirer 101 identifies the category names “PHARMACEUTICAL” and “FOODS” corresponding to the identified product IDs “G102,” “G301,” and “G401.”

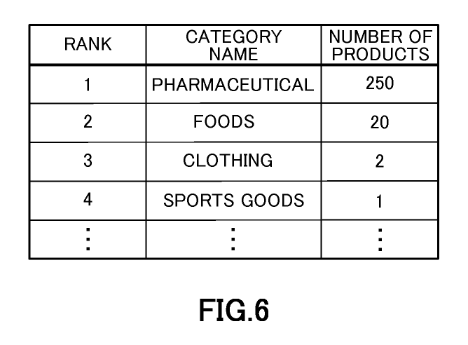

Then, the acquirer 101 sorts the identified category names in the descending order of the number of products associated with the category name among the identified products. Then, the acquirer 101 acquires the category names which have higher or equal to ranks than a predetermined rank, for example the highest-ranking category name, namely the category name with which the largest number of products are associated, among the sorted category names. FIG. 6 shows exemplary results of sorting the category names of products that match the entered product name “STOMACH MEDICINE B” by the number of corresponding products. The acquirer 101 acquires the highest-ranking category name “PHARMACEUTICAL” based on the results shown in FIG. 6.

In this embodiment, the controller 110 and communicator 150 cooperate to function as the acquirer 101.

If a category name is entered and the entered category name and the category name acquired by the acquirer 101 do not match, the determiner 102 determines that at least either one of the entered product name and entered category name is entered incorrectly.

More specifically, the determiner 102 acquires the product category name from the registration request data acquired from the store terminal 400. Then, the determiner 102 determines whether the entered category name and the category name acquired by the acquirer 101 match. If they do not match, the determiner 102 determines that either the entered product name and/or entered category name have been entered incorrectly. For example, if the product name and category name entered from the store terminal 400 are “STOMACH MEDICINE B” and “FOODS,” respectively, and the category name acquired by the acquirer 101 is “PHARMACEUTICAL,” the determiner 102 determines that the category names do not match. Then, the determiner 102 determines that at least either the entered product name “STOMACH MEDICINE B” and/or entered product name “FOODS” have been entered incorrectly.

In this embodiment, the controller 110 and communicator 150 cooperate to function as the determiner 102.

If the determiner 102 determines that either the entered product name and/or entered category name have been entered incorrectly, the indicator 103 identifies a category name ranked higher than the entered category name among the sorted category names and indicates replacement of the entered category name with the identified category name.

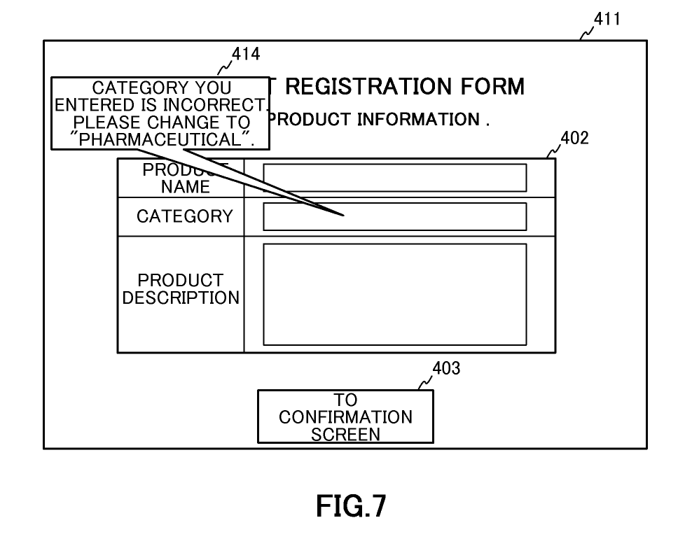

For example, if the determiner 102 determines that either the entered product name “STOMACH MEDICINE B” and/or the entered category name “FOODS” is entered incorrectly, the indicator 103 identifies the category name “PHARMACEUTICAL” ranked higher than the entered category name “FOODS” among the category names sorted as shown in FIG. 6. Then, the indicator 103 indicates to the store terminal 400 replacement of the entered category name “FOODS” with the identified category name “PHARMACEUTICAL.” As an exemplary method of indicating replacement of the category name, the indicator 103 provides a product registration page 411 shown in FIG. 7 to the store terminal 400. The product registration page 411 contains a message 414 displayed near the entry form 412 and reading “CATEGORY YOU ENTERED IS INCORRECT. PLEASE CHANGE TO ‘PHARMACEUTICAL.’” The indicator 103 suggests to the user of the store terminal 400 replacement of the entered category name “FOODS” with the identified category name “PHARMACEUTICAL” by means of the message 414.

Incidentally, if there are multiple category names ranked higher than the entered category name among the sorted category names, the indicator 103 indicates replacement of the entered category name with any of a given number (for example, three) of higher-ranking category names.

In this embodiment, the controller 110 and communicator 150 cooperate to function as the indicator 103.

If the determiner 102 determines that the category names match, the registration processor 104 registers data contained in the registration request data in the products database 200.

In this embodiment, the controller 110 functions as the registration processor 104.

Operation of the processing device 100 according to this embodiment will be described hereafter.

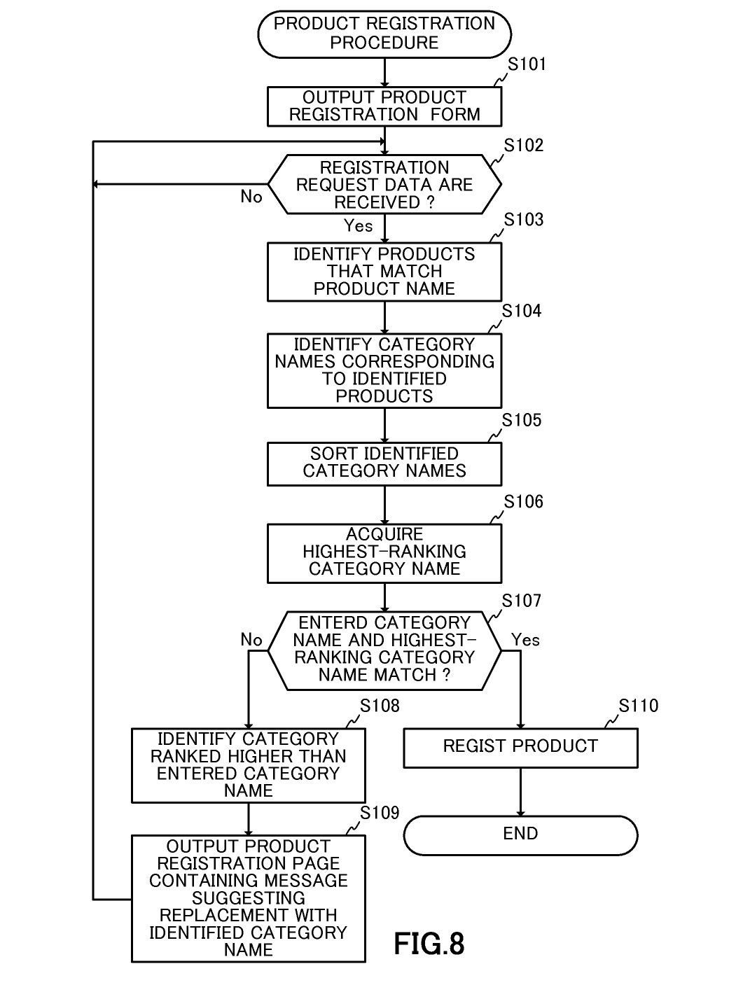

The product registration procedure executed by the controller 110 of the processing device 100 will be described. FIG. 8 is an exemplary flowchart of the product registration procedure. The product registration procedure shown in FIG. 8 starts when, for example, input of a request for registering a product is received from the store terminal 400. Furthermore, this procedure is executed by, for example, the CPU of the controller 110 reading programs stored in the ROM 120.

The acquirer 101 outputs the product registration form 401 shown in FIG. 5 to the store terminal 400 (Step S101).

Then, the acquirer 101 determines whether registration request data are received from the store terminal 400 (Step S102). The acquirer 101 waits until registration request data are received (Step S102; No). Triggered by a button “TO CONFIRMATION SCREEN” 403 being selected by the user, the store terminal 400 outputs registration request data entered in the entry form 402 to the processing device 100.

If the acquirer 101 determines that registration request data are received from the store terminal 400 (Step S102; Yes), the acquirer 101 identifies products in the products database 200 that match the product name contained in the registration request data (Step S103).

Subsequently, the acquirer 101 identifies, for each of the products identified in the Step S103, the category name associated with the product (Step S104).

Subsequently, the acquirer 101 sorts the category names identified in the Step S104 in the descending order of the number of products associated with the category name among the products identified in the Step S103 (Step S105).

Subsequently, the acquirer 101 acquires the highest-ranking category name among the category names sorted in the Step S105 (Step S106).

Then, the determiner 102 determines whether the category name entered by the user of the store terminal 400 and contained in the registration request data acquired in the Step S102 and the category name acquired in the Step S106 match (Step S107).

If the determiner 102 determines that the category name entered by the user of the store terminal 400 and the category name acquired in the Step S106 do not match (Step S107; No), the indicator 102 identifies a category name ranked higher than the category name entered by the user of the store terminal 400 among the category names sorted in the Step S105 (Step S108).

Then, the indicator 103 outputs to the store terminal 400 the product registration form 411 (see FIG. 7) containing the message 414 suggesting to the user replacement of the entered category name with the category name identified in the Step S108 (Step S109). Then, the procedure returns to the Step S102.

If the determiner 102 determines that the category name entered by the user and the category name acquired in the Step S106 match (Step S107; Yes), the registration processor 104 registers data contained in the registration request data acquired in the Step S102 in the products database 200 (Step S110). Then, the procedure ends.

As described above, as the product name and the category name of the product are entered by the user of the store terminal 400, the processing device 100 of this embodiment identifies category names corresponding to the entered product name in the products database 200. Then, if the category name corresponding to many products among the identified category names and the entered category name do not match, the processing device 100 determines that either the entered product name and/or category name have been entered incorrectly. Thus, the incorrect product name and category name entered by the user of the store terminal 400 are not registered in the products database 200 as they are.

Furthermore, if it is determined that either the entered product name and/or category name have been entered incorrectly, the processing device 100 of this embodiment indicates replacement of the entered category name with the category name corresponding to many products. Thus, the user of the store terminal 400 can easily enter a proper category name to which the product to be registered belongs.

An embodiment of the present disclosure is described above. The present disclosure is not confined to the above embodiment. Modified embodiments of the embodiment will be described below. In the following modified embodiments, the same components as those of the above embodiment are referred to by the same reference numbers and their detailed explanation will be omitted.

### Modified Embodiment 1

In the above embodiment, the determiner 102 determines that either one of the entered product name and/or entered category name have been entered incorrectly when the entered category name and the category name acquired by the acquirer 101 do not match. However, the determiner 102 can determine whether there is incorrect input in a more detailed manner. For example, when the entered category name and the category name acquired by the acquirer 101 do not match, the determiner 102 identifies product names corresponding to the entered category name in the products database 200. Then, when the entered product name matches none of the identified product names, the determiner 102 determines that either the entered keyword and/or entered category name have been entered incorrectly. Incidentally, the determiner 102 can determine that the entered product name and identified product name match not only when the entered product name and identified product name completely match but also when they are similar, in other words they are equivalent according to a given or higher criterion.

In other words, if the entered category name and product name match the product name and the category name registered in the products database 200, respectively, it is highly likely that the entered category name and product name are entered correctly. Thus, in the event that the entered category name and the category name acquired by the acquirer 101 do not match but the entered category name and product name match the product name and the category name already registered in the products database 200, respectively, the determiner 102 does not have to assume incorrect input. This arrangement prevents the user of the store terminal 400 from being annoyed by indication of incorrect input in spite of correct input when the user tries to register a new product of which the registration in the products database 200 is low in number.

### Modified Embodiment 2

In addition to the determination method in the above-described Modified Embodiment 1, as another method of determining whether there is incorrect input in a more detailed manner, it is possible that when the entered category name and the category name acquired by the acquirer 101 do not match, the determiner 102 determines whether the entered product name appears in entered product description and, if it does not appear, determines that either the entered product name and/or entered product description have been entered incorrectly.

Generally, the product name is used in the description of the product. For that reason, if the entered product name does not appear in the entered product description, it is highly likely that at least either one of the entered product name and entered product description contains an error. Thus, indicating that either the entered product name and/or entered product description have been entered incorrectly when the entered product name does not appear in the entered product description can prevent the user from registering an incorrect product name.

In the above-described embodiment and modified embodiments, some arrangement can be modified as follows.

For example, in the above-described embodiment and modified embodiments, the acquirer 101 identifies products in the products database 200 that match the product name contained in the registration request data acquired from the store terminal 400. However, the keyword used by the acquirer 101 in identifying the products in the products database 200 is not limited to the product name. For example, the acquirer 101 can use, instead of the product name, part of the product description contained in the registration request data as the keyword and identify products in the products database 200 that match the part of the product description. In such a case, the determiner 102 can determine whether there is incorrect input in the part of the entered product description and the entered category name.

Furthermore, in the above-described embodiment and modified embodiments, when the determiner 102 determines that either the entered product name and/or category name have been entered incorrectly, the indicator 103 indicates replacement of the entered category name with a category name corresponding to many products on the store terminal 400. However, the indicator 103 can indicate incorrect input without indicating the replacement. In such a case, indication of incorrect input makes the user of the store terminal 400 realize the incorrect input in the data he entered and correct the incorrect input.

Furthermore, in the above-described embodiment and modified embodiments, triggered by the button 403 being selected, the store terminal 400 outputs registration request data to the processing device 100, and the acquirer 101 acquires information regarding a product to register in the products database 200 from the store terminal 400. The method of acquiring information regarding a product is not limited thereto. For example, it is possible that each time data are entered in the entry form 402, the processing device 100 receives the data from the store terminal 400 and determines whether there is incorrect input based on the received data. In other words, the processing device 100 can determine whether there is incorrect input in real time, not after the button 403 is selected. Furthermore, the processing device 100 can acquire a list containing information regarding multiple products from the store terminal 400 instead of acquiring information regarding a product via the product registration form 401. In such a case, the processing device 100 can determine whether there is incorrect input as in the above-described embodiment for each of the products contained in the list.

Furthermore, the method of the indicator 103 indicating replacement of the category name is not limited to the method of displaying the message 414 on the product registration form 411 as described in the above-described embodiment. For example, it is possible that the indicator 103 sends to the store terminal 400 an email containing a message suggesting replacement of the category name to indicate replacement of the category name. Furthermore, the store terminal 400 can send information regarding a product to register in the products database 200 from the system established at the store to the processing device 100 using a FTP (File Transfer Protocol). In such a case, the processing device 100 can indicate to the store terminal 400 a warning such as “the product category name is likely to be incorrect” along with registering the information sent from the store terminal 400 in the products database 200.

Incidentally, in the above-described embodiment, the programs executed by the processing device 100 can be saved and distributed on a non-transitory computer-readable recording medium such as a flexible disc, CD-ROM (Compact Disk Read-Only Memory), DVD (Digital Versatile Disk), and MO (Magneto-Optical disk). Then, the programs can be installed on an information processing device such as a personal computer to configure the processing device 100 executing the above-described procedure.

Alternatively, the programs can be saved in a storage device of a given server unit on a communication network such as the Internet, Then, for example, the programs can be superimposed on carrier waves and downloaded.

Furthermore, when the above-described functions are realized by an OS (operation system) in part or by cooperation of an OS and application programs, only the programs other than those realizing the function of the OS can be saved and distributed on a non-transitory recording medium or downloaded.

Various embodiments and modifications are available to the present disclosure without departing from the broad sense of spirit and scope of the present disclosure. The above-described embodiments are given for explaining the present disclosure and do not confine the scope of the present disclosure. In other words, the scope of the present disclosure is set forth by the scope of claims, not by the embodiments. Various modifications made within the scope of claims and scope of significance of the disclosure equivalent thereto are considered to fall under the scope of the present disclosure.

### INDUSTRIAL APPLICABILITY

The present disclosure is suitable for electronic trading using a network such as the Internet.

### REFERENCE SIGNS LIST

1 Information processing system
100 Processing device
101 Acquirer
102 Determiner
103 Indicator
104 Registration processor
110 Controller
120 ROM
130 RAM
140 Display
150 Communicator
160 Operator
170 Bus
200 Products database
300 Information providing device
400 Store terminal
401, 411 Product registration page
402, 422 Entry form
403, 413 Button
414 Message
500 Buyer terminal
600 Internet

1. A processing device, comprising:
an acquirer that, after a keyword is entered, sorts category names of products that match the keyword in a descending order of a number of products associated with the category name among the products that match the keyword to acquire the category names which have higher or equal to ranks than a predetermined rank and
a determiner that, as a category name is entered, determines that at least either the entered keyword and/or entered category name have been entered incorrectly when the entered category name and acquired category name do not match.

2. The processing device according to claim 1, further comprising:
an indicator identifying a category name ranked higher than the entered category name among the sorted category names and indicating replacement of the entered category name with the identified category name when it is determined that either the entered keyword and/or the entered category name have been entered incorrectly.

3. The processing device according to claim 2, wherein
the indicator indicates replacement with any of a given number of higher-ranking category names when there are multiple category names ranked higher than the entered category name.

4. The processing device according to claim 1, wherein
the keyword is a product name.

5. The processing device according to claim 4, wherein
the determiner determines that either one of the entered product name and/or entered category name have been entered incorrectly when the entered category name and acquired category name do not match and the entered product name matches none of product names corresponding to the entered category name.

6. The processing device according to claim 4, wherein
after product description is entered, the determiner determines that either the entered product name and/or entered product description have been entered incorrectly when the entered category name and acquired category name do not match and the entered product name does not appear in the entered product description.

7. The processing device according to claim 1, wherein
the keyword is part of product description.

8. A processing method executed by a processing device comprising an acquirer and a determiner, comprising:
sorting, after a keyword is entered, category names of products that match the keyword in a descending order of a number of products associated with the category name among the products that match the keyword to acquire the category names which have higher or equal to ranks than a predetermined rank; and
determining, as a category name is entered, that either the entered keyword and/or entered category name have been entered incorrectly when the entered category name and acquired category name do not match.

9. (canceled)

10. A computer-readable recording medium on which a program is recorded that allows a computer to function as:
an acquirer that, after a keyword is entered, sorts category names of products that match the keyword in a descending order of a number of products associated with the category name among the products that match the keyword to acquire the category names which have higher or equal to ranks than a predetermined rank; and
a determiner that, as a category name is entered, determines that either the entered keyword and/or entered category name have been entered incorrectly when the entered category name and acquired category name do not match.
